(19) United States
(12) Patent Application Publication
(10) Pub. No.: US 2004/0261640 A1
(43) Pub. Date: Dec. 30, 2004

(54) Lateral sealing device for doctor blade inking chambers of inking rolls for flexographic rotary printing machines

(76) Inventors: Roberto Maccagni, Podenzano (IT); Oscar Xerra, Piacenza (IT)

Correspondence Address: STITES & HARBISON PLLC, 1199 NORTH FAIRFAX STREET, SUITE 900, ALEXANDRIA, VA, 22314, US

(21) Appl. No.: 10/874,193

(22) Filed: Jun. 24, 2004

(30) Foreign Application Priority Data
Jun. 25, 2003 (IT) GE2003A000044

(51) Int. Cl. B41F 1/40

(52) U.S. Cl. 101/350.6

(57) ABSTRACT

Lateral sealing device for doctor blade inking chambers of inking rolls for flexographic rotary printing machines, of the type comprising a rigid cassette housing a sealing element. The said sealing element is made in the form of a hollow body made from rubber or from elastomeric material having a consistency similar to that of rubber, closed on five sides and open on the side facing the end of the inking chamber, the side facing the inking roll being shaped in such a way as to have a curvature equal to that of the said roll, and provided with sides inclined in a way corresponding to the inclination of the scraper blades, an elastic element being housed inside the said hollow body and constantly pressing, with a substantially constant force, the side of the said hollow body interacting with the inking roll against the periphery of the inking roll.

### BACKGROUND AND SUMMARY OF THE INVENTION

The present invention relates to lateral sealing devices for doctor blade inking chambers of inking rolls for flexographic rotary printing machines.

Known inking chambers are closed at their ends by means of suitable closing devices, known as “cassettes”, comprising an outer rigid casing closed on four sides and housing a seal, made of felt or similar materials for example, which acts as an end seal against the ends of the inking chamber and as a peripheral seal against the inking roll and the scraper blades, or “doctor blades”, of the inking chamber. These known sealing systems with felt seals have a number of drawbacks, including the fact that they do not provide a perfect seal over time; for example, they do not adequately compensate for the inevitable wear due to their friction against the periphery of the inking roll, and furthermore their service life is very limited.

The object of the present invention is therefore to provide a lateral sealing device for doctor blade inking chambers of inking rolls for flexographic rotary printing machines, which has a long service life and provides a perfect seal with the minimum force of application required on the periphery of the inking roll, regardless of the wear of its surface in contact with the inking roll and/or independently of the degree of wear of the doctor blades and therefore independently of the positioning and adjustment of the inking chamber.

This object is achieved by making the sealing device housed in the cassette in the form of a hollow body made from rubber or from elastomeric material having a consistency similar to that of rubber, closed on five sides and open on the side facing the end of the inking chamber, the side facing the inking roll being shaped in such a way as to have a curvature equal to that of the said roll, and provided with sides inclined in a way corresponding to the inclination of the scraper blades, an elastic element being housed inside the said hollow body, this element being made in the form of a spring steel wire forming an open ring shaped in a complementary way which constantly presses, with a substantially constant force, the side of the said hollow body interacting with the inking roll against the periphery of the inking roll.

### BRIEF DESCRIPTION OF THE DRAWINGS

Further characteristics and advantages of the present invention will be understood more clearly from the following description, provided purely by way of example and without restrictive intent, with reference to the attached drawings, in which:

FIG. 1 shows a side elevation of an inking chamber having a sealing device according to the present invention at its ends, the partial profile of the inking roll against which the said chamber is applied being shown in chained lines;

FIG. 2 shows a partial plan view from the rear of one of the two ends of the inking chamber shown in FIG. 1;

FIG. 3 shows an exploded perspective view of a lateral sealing cassette of the inking chamber with the seal elements housed in it, according to the present invention;

FIG. 4 shows a side elevation of the sealing device of FIG. 3, fully assembled, and

FIG. 5 is a cross-sectional view on an enlarged scale, taken through the line V-V of the device of FIG. 4.

### DESCRIPTION OF THE PREFERRED EMBODIMENT OF THE INVENTION

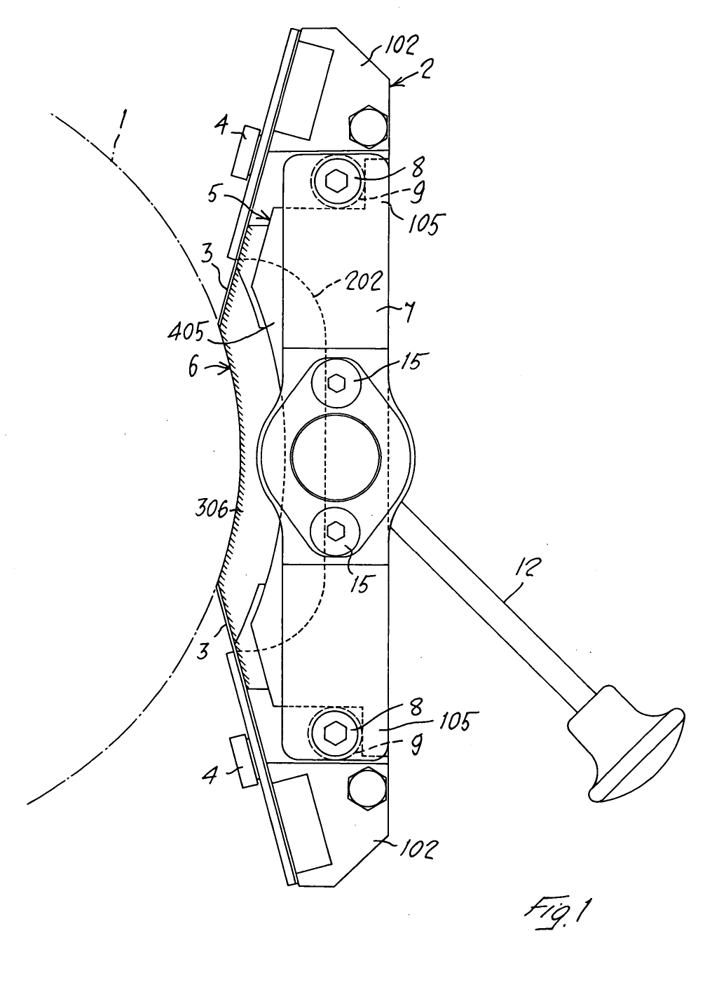

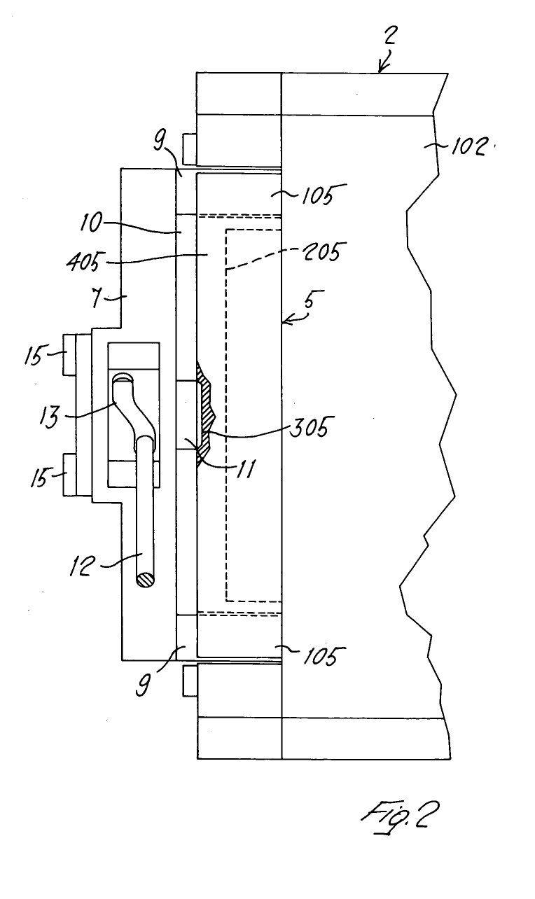

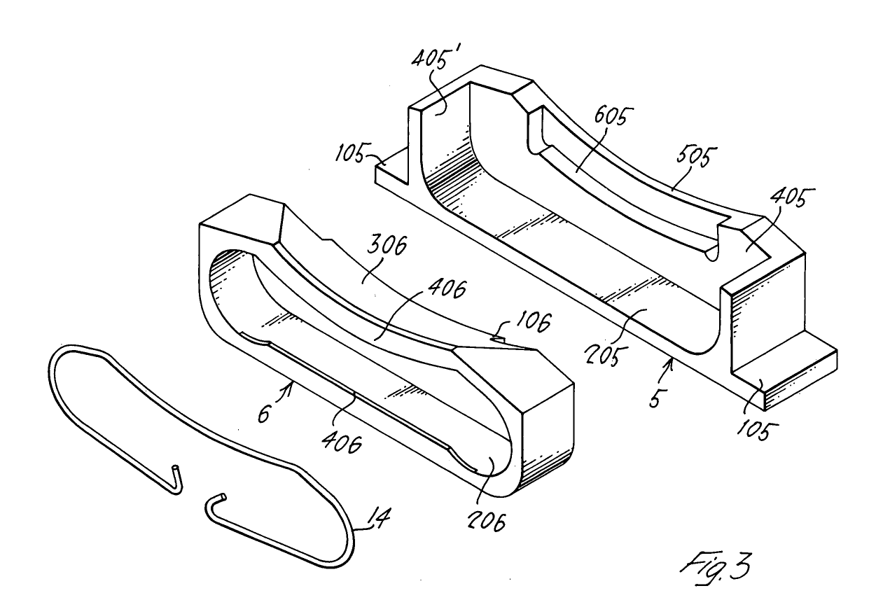

With reference to the drawings and with particular reference to FIGS. 1 and 2, the number 1 indicates the partial profile, shown in broken lines, of an inking roll of a flexographic printing machine which is not shown. Against a predetermined section of the peripheral shell of the roll 1 there is applied, with a seal, the inking chamber 2, which extends over the whole height of the shell of the roll 1. This chamber 2 comprises a boxlike casing 102 which is provided, on the side facing the roll 1, with an aperture 202 which extends substantially from an area close to one end of the roll 1 to an area close to the other end of the said roll 1. Two scraper blades 3, or “doctor blades”, fixed to the chamber 2 by suitable pins 4, extend from the front side of the chamber 2 in the direction of the roll 1. The doctor blades 3 are positioned, in a known way, with a certain angle of incidence with respect to the roll 1 over the whole length of the boxlike casing 102 of the chamber 2 and in direct contact with the surface of the shell of the said roller 1. The chamber 2 is closed at each of its two ends by a sealing device or “cassette” comprising, as shown more clearly in FIG. 3, a suitably shaped rigid support 5 in which is housed a seal 6 made from rubber or other elastomer, positioned in direct contact with both the outer surface of the roll 1 and the inner surfaces of the ends of the two doctor blades 3.

The chamber 2 is connected in a known way to the ink feed passages (not shown) and comprises, at each end, a plate 7 having means for rapidly locking the cassettes 5 in position. For this purpose, the plate 7 is connected to the sides of the casing 102 of the chamber 2 by means of two pins 8 provided with spacers 9 in such a way as to form a compartment 10 between the said plates 7 and the ends of the chamber 2, for housing the cassettes of the sealing device. As shown more clearly in FIG. 3, each lateral sealing cassette comprises a rigid casing 5 consisting substantially of a parallelepiped carrying at its ends two outwardly projecting tabs 105 and having an internal hollow housing 205 closed by an end wall 405 and by two side pieces 405′.

A circular cavity 305 is formed on the outer side of the wall 405 (FIG. 5). This circular cavity 305 engages with the free end of a small locking plunger 11 which is made to move towards and away from the outer wall of the cassette 5 by a lever 12 interacting with a camlike frontal guide 13. This camlike frontal guide 13 is connected to the locking plate 7 by means of two screws 15.

The cassette 5 houses a hollow body 6 made from rubber or from elastomeric material having a consistency similar to that of rubber. A cavity 206 is formed in this body 6. In the area of contact with the roll 1 (FIG. 1), this body 6 has a truncated conical wall 306, having a radius of curvature initially corresponding to that of the said roll 1 and increasing from the inside to the outside of the body 6. The cavity 206 has on its front edge, in other words on the edge facing the inking chamber, a channel for housing an elastic element 14 in the form of an open ring of spring steel wire, shaped in a complementary way, which constantly presses, with a constant force, the side of the said hollow body interacting with the inking roll against the periphery of the inking roll 1.

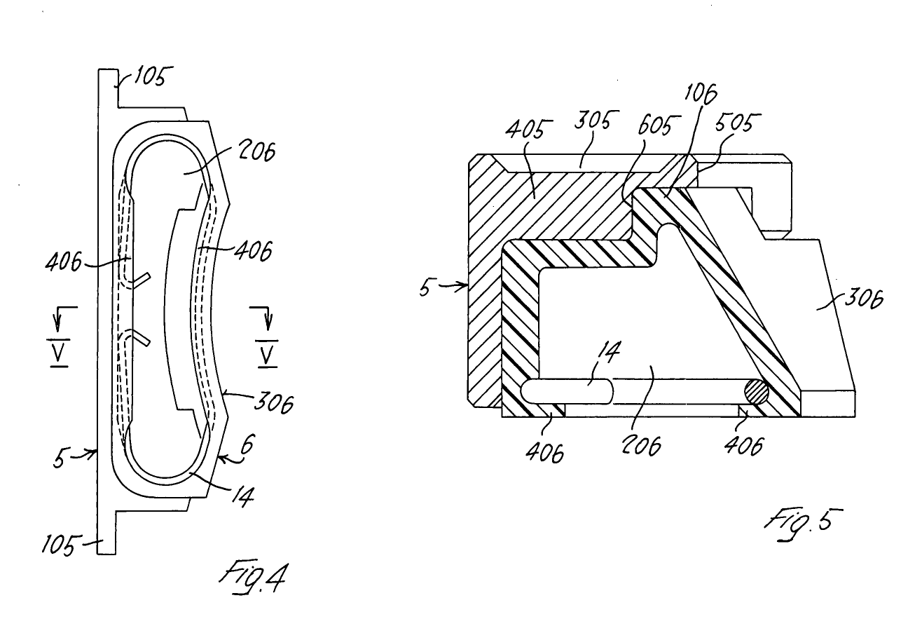

FIGS. 4 and 5 show two views of the present device when assembled. The lateral wall 405 of the rigid support 5 has a curved edge 505 in its lower part and an internal curved step 605 for supporting a corresponding curved projecting part 106 formed on the outer side of the rubber body 6.

The presence of the spring 14 inside the cavity 206 of the seal 6 is very important, because it enables the elasticity of the said rubber seal 6 to be kept unvaried as a function of the sealing pressure, owing to the fact that its profile exactly matches that of the roll 1. This spring 14 also enables the inevitable wear of the doctor blades 3 to be compensated by making the chamber 2 advance independently of the seal 6.

The step 605 for supporting the curved outer projection 106 of the seal 6, formed in the lateral wall 405 of the rigid support 5, also enables the truncated conical wall 306 to have a relatively large initial radius of curvature, which improves its deformability.

We claim:

1. Lateral sealing device for doctor blade inking chambers of inking rolls for flexographic rotary printing machines, of the type comprising a rigid cassette housing a sealing element, wherein the said sealing element is made in the form of a hollow body made from rubber or from elastomeric material having a consistency similar to that of rubber, closed on five sides and open on the side facing the end of the inking chamber, the side facing the inking roll being shaped in such a way as to have a curvature equal to that of the said roll, and provided with sides inclined in a way corresponding to the inclination of the scraper blades, an elastic element being housed inside the said hollow body and constantly pressing, with a substantially constant force, the side of the said hollow body interacting with the inking roll against the periphery of the inking roll.

2. Device according to claim 1, in which the said elastic element is made in the form of an open ring of spring steel wire shaped in a way which is complementary to the said hollow body.

3. Sealing device according to claim 1, in which the said lateral wall of the rigid support comprises a curved internal step for supporting a curved part projecting from the rubber seal.

4. Sealing device according to claim 1, in which the said rubber seal comprises, on the side for contacting the inking roll, a truncated conical wall shaped in such a way that its inner edge fits exactly against the outer profile of the said inking roll.

5. Sealing device according to claim 1, in which a substantially elliptical cavity is formed inside the said seal.

6. Sealing device according to claim 5, in which the said elliptical cavity has a raised edge in which the said elastic means is housed.

7. Sealing device according to claim 1, in which the said truncated conical wall of the seal has a radius of curvature increasing from the inside to the outside of the said seal.
